(19) United States
(12) Patent Application Publication
(10) Pub. No.: US 2015/0309977 A1
(43) Pub. Date: Oct. 29, 2015

(54) DOCUMENT MANAGEMENT APPARATUS AND RECORDING MEDIUM FOR EASY REGISTER AND DISPLAY OF CHARACTER STRING INDICATING MEANING

(71) Applicant: KYOCERA Document Solutions Inc., Osaka (JP)

(72) Inventors: Katsuhiro MINORU, Osaka (JP); Jumpei TAKAGI, Osaka (JP); Chika TSUJI, Osaka (JP); Daisuke YOSHIDA, Osaka (JP); Takashi NOMURA, Osaka (JP); Yuichi OBAYASHI, Osaka (JP); Takeshi NAKAMURA, Osaka (JP)

(73) Assignee: KYOCERA Document Solutions Inc., Osaka (JP)

(21) Appl. No.: 14/696,376

(22) Filed: Apr. 25, 2015

(30) Foreign Application Priority Data
Apr. 25, 2014 (JP) 2014-090830
Jul. 31, 2014 (JP) 2014-156338

(51) Int. Cl. G06F 17/24; G06F 17/30; G06F 17/22

(52) U.S. Cl. CPC G06F 17/241; G06F 17/2276; G06F 17/30312

(57) ABSTRACT

A document management apparatus includes a reading circuit, a storage circuit, and a control circuit. The control circuit has: a character string registration mode that causes the reading circuit to read the document, detects a character string to be annotated based on a position of the read marking, searches the note of the detected character string in a dictionary, and causes the storage circuit to store the detected character string and the searched note to register the character string, and a sentence output mode that accepts a sentence, collates the accepted sentence with the character string stored in the storage circuit, obtains the note of the character string found to be matched by the collation, and makes the obtained note correspond to the matched character string to output the obtained note together with the sentence, so as to output the sentence.

### INCORPORATION BY REFERENCE

This application is based upon, and claims the benefit of priority from, corresponding Japanese Patent Application No. 2014-090830 filed on Apr. 25, 2014 and No. 2014-156338 filed on Jul. 31, 2014 in the Japan Patent Office, the entire contents of which are incorporated herein by reference.

### BACKGROUND

Unless otherwise indicated herein, the description in this section is not prior art to the claims in this application and is not admitted to be prior art by inclusion in this section.

For learning one's native language (English) and foreign languages, extensive reading is considered to be one of the effective means. Nowadays, many sentences are available to read for learning via Internet or a similar way.

However, such as the sentences obtained via Internet are not written for a learner in a specific level as a target. Then, the sentences could not be said appropriate to language learning as they are.

Accordingly, for example, a typical technique attaches an attribution to each of foreign words, idioms, and phrases. To the word, idiom, and phrase that a user has learned already, the attribution of “learned” is attached. To the word, idiom, and phrase that the user should learn next, the attribution of “learning” is attached. Then, when converting the obtained English sentence to plain English sentence, in the case of converting to the English sentence for learning, the words of “learned” and “learning” are used to convert. In the case of converting to the English sentence for understanding the content, only the word of “learned” is used to convert.

### SUMMARY

A document management apparatus according to an aspect of the disclosure includes a reading circuit, a storage circuit, and a control circuit. The reading circuit reads a character string and a marking from a document where a character string is marked. The control circuit has: a character string registration mode that causes the reading circuit to read the document, detects a character string to be annotated based on a position of the read marking, searches the note of the detected character string in a dictionary, and causes the storage circuit to store the detected character string and the searched note to register the character string, and a sentence output mode that accepts a sentence, collates the accepted sentence with the character string stored in the storage circuit, obtains the note of the character string found to be matched by the collation, and makes the obtained note correspond to the matched character string to output the obtained note together with the sentence, so as to output the sentence.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates an outline of a document management apparatus according to a first embodiment of the disclosure;

FIG. 2 illustrates a general configuration of the document management apparatus according to the first embodiment;

FIG. 3 illustrates a configuration where the document management apparatus according to the first embodiment is realized as an image forming apparatus;

FIG. 4 illustrates a configuration where the document management apparatus according to the first embodiment is realized as a client/server type document management system mainly an image forming apparatus;

FIG. 5 illustrates a flow of a process in a character string registration mode according to the first embodiment;

FIG. 6 illustrates an example of information registered in a storage unit according to the first embodiment;

FIG. 7 illustrates an example of a method for a user to specify a user identifier and a user attribution that are criteria to select a character string that a note is inserted in a sentence output mode according to the first embodiment;

FIG. 8 illustrates a flow of a process in the sentence output mode according to the first embodiment;

FIG. 9 illustrates an example that a character string (note) indicating a meaning of a character string corresponding to the user identifier and the user attribution specified by the user is inserted to an obtained sentence in the first embodiment;

FIG. 10 illustrates an example of information stored in a storage unit according to the second embodiment; and

FIG. 11 illustrates a flow of a process in a sentence output mode according to the second embodiment.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes each embodiment of the disclosure by referring to drawings.

### First Embodiment

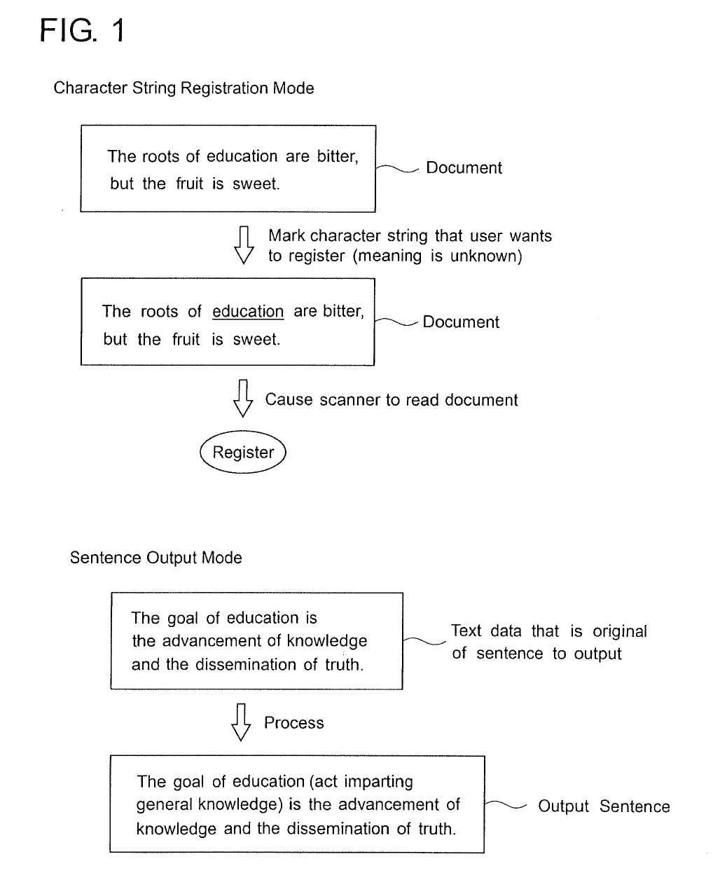

FIG. 1 illustrates an outline of a document management apparatus according to the first embodiment of the disclosure.

As illustrated in FIG. 1, the document management apparatus according to the first embodiment of the disclosure performs in two modes, a character string registration mode and a sentence output mode.

The character string registration mode registers a character string, such as a character string that the user does not know its meaning, to attach a note in the document management apparatus. The registration employs, for example, a method of underlining the character string to register on a paper document that the character string to register is written.

In an example of FIG. 1, when the user does not know the meaning of “education” and wants to attach a note in a sentence, “the roots of education are bitter, but the fruit is sweet,” written on the paper document, the user draws a line under “education” to cause the document management apparatus to read the mark.

Thus, the user can register the character string to attach the note such as an unknown character string easily by marking the character string on the paper document in the document management apparatus.

The document management apparatus reads “education,” searches “education” in a dictionary, and obtains the character string (the note) indicating the meaning of “act imparting general knowledge.”

Next, in the sentence output mode, as illustrated in FIG. 1, the document management apparatus obtains text data, which becomes the original of the sentence to output, from the user. This text data is any sentence not limited to the document read in the character string registration mode.

With “education” registered in the document management apparatus, after the text data “education,” the character string of “act imparting general knowledge” is inserted as the note of “education.” The sentence with the inserted note is displayed on a display apparatus or printed by a print apparatus to present to the user.

Thus, the user can insert the note of the registered character string easily to the sentence to output.

The outline of the document management apparatus according to the first embodiment of the disclosure is described above.

Next, the configuration of the document management apparatus according to the first embodiment of the disclosure will be described. The following describes a general configuration of the document management apparatus at first. Then, a description will be given of the configuration according to an embodiment that the document management apparatus is realized as a Multifunction Peripheral (MFP). Furthermore, a description will be also given of the configuration where the document management apparatus is realized as a client/server type configuration via a network.

### Configuration of General Document Management Apparatus

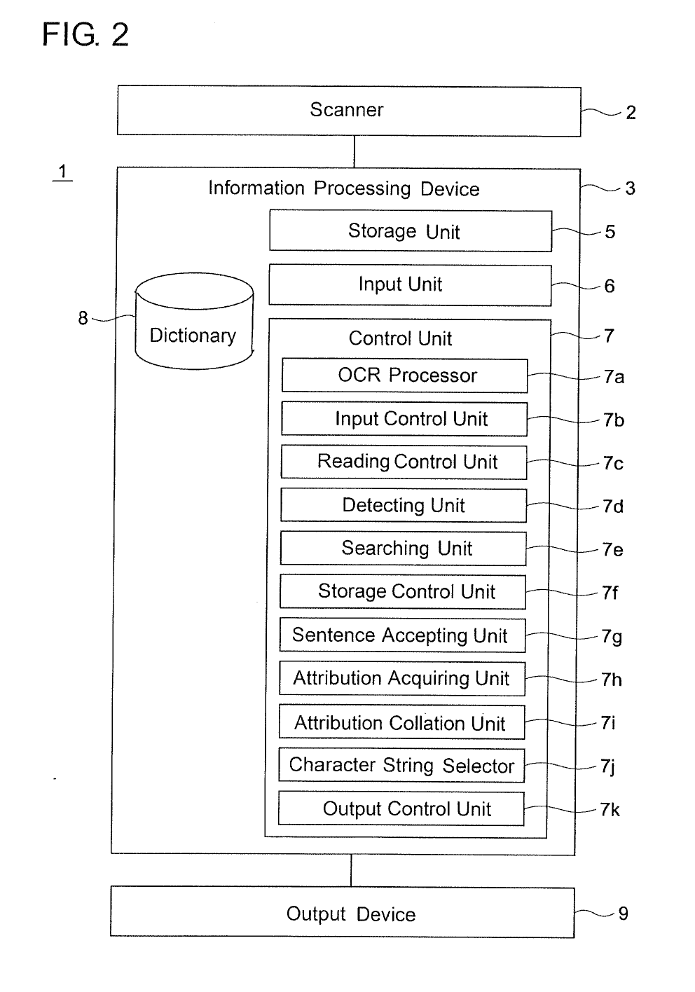

FIG. 2 illustrates a general configuration of a document management apparatus 1. The document management apparatus 1 includes a scanner 2, an information processing device 3, and an output device 9.

The scanner 2 reads the document in the character string registration mode. The scanner 2 reads the sentence, which becomes the original of the sentence to output, in the sentence output mode.

The output device 9 is a display apparatus such as a display, a print apparatus such as a printer, a network equipment transmitting data to external equipment on the network, or similar device. The output device 9 is a device that outputs the sentence with the inserted note.

The information processing device 3 can be realized by using a common computer. The information processing device 3 includes a storage unit 5, an input unit 6, a control unit 7, and a dictionary 8.

The storage unit 5 is a circuit such as a memory that stores the character string registered by the user, the character string that indicates the meaning of the character string registered by the user, a user identifier (described below), a user attribution (described below), and similar data.

The input unit 6 is a memory that accepts to input the user identifier and the user attribution from the user.

The dictionary 8 registers many character strings and the character strings (the notes) indicating the meaning of the registered character strings.

The control unit 7 is constituted with a Central Processing Unit (CPU), a Random Access Memory (RAM), a Read Only Memory (ROM), an exclusive hardware circuit and similar components and manages the whole operation control of the information processing device 3. The control unit 7 includes an Optical Character Recognition (OCR) processor 7a, an input control unit 7b, a reading control unit 7c, a detecting unit 7d, a searching unit 7e, a storage control unit 7f, a sentence accepting unit 7g, an attribution acquiring unit 7h, an attribution collation unit 7i, a character string selector 7j, and an output control unit 7k. The control unit 7 executes the processes in the above-described two modes.

The OCR processor 7a is a circuit that detects characters from the image data of the document read by the scanner 2 to generate electronic text data. The combination of the scanner 2 and the OCR processor 7a corresponds to a reading circuit.

The input control unit 7b is a circuit that controls the input unit 6. The input control unit 7b causes the input unit 6 to accept the attribution of the user (registrant) who registers the character string in the character string registration mode. The input control unit 7b causes the input unit 6 to accept the attribution of the user (output person) who outputs the sentence in the sentence output mode.

The reading control unit 7c is a circuit that causes the scanner 2 to read the document where the character string to register in the character string registration mode is marked.

The detecting unit 7d is a circuit that detects the character string to register for attaching the note based on the position of the mark read from the document.

The searching unit 7e is a circuit that searches the character string that is detected by the detecting unit 7d in the dictionary 8.

The storage control unit 7f is a circuit that causes the storage unit 5 to store the character string detected from the document, the note searched in the dictionary 8, and the attribution of the user who registers the character string so as to be associated with each other.

The sentence accepting unit 7g is a circuit that accepts the sentence that the user outputs in the sentence output mode. The sentence accepting unit 7g may cause the input unit 6 to accept the sentence to output.

The attribution acquiring unit 7h is a circuit that acquires the attribution of the writer who created the accepted sentence based on the document information of the sentence accepted to output.

The attribution collation unit 7i is a circuit that collates the attribution of the user who outputs the sentence, the attribution of the writer who created the sentence obtained by the attribution acquiring unit 7h, and the attribution of the user who registered the character string.

The character string selector 7j is a circuit that selects the character string to insert the note, which is selected from the character strings stored in the storage unit 5, among the character strings included in the sentence to output based on the collation result by the attribution collation unit 7i.

The output control unit 7k is a circuit that outputs the note to the character string selected by the character string selector 7j with the sentence to the output device 9 while making the note correspond to the character string in the sentence to output.

The configuration example of the document management apparatus 1 is described above.

### Configuration of Document Management Apparatus Realized as Image Forming Apparatus

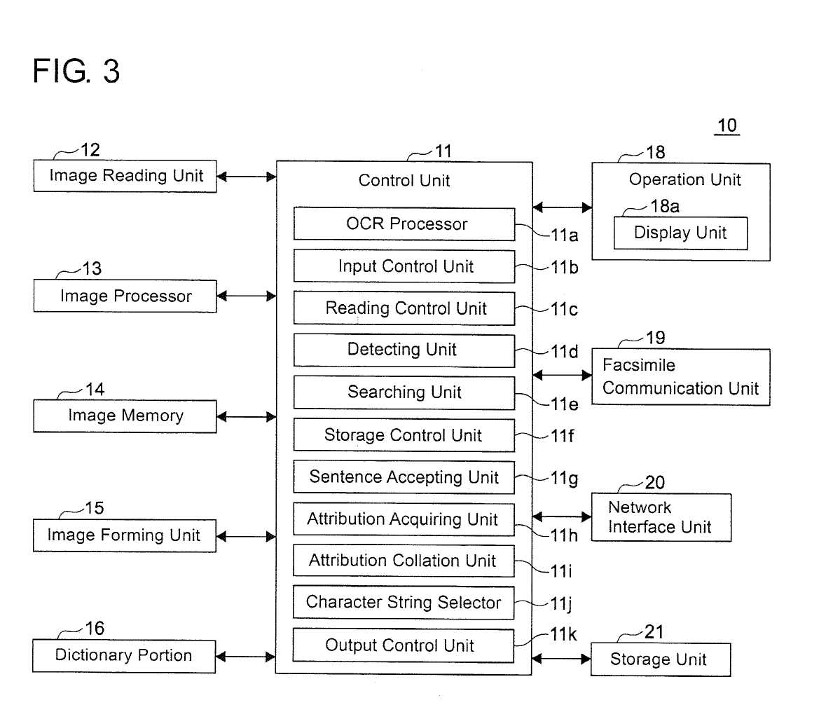

Next, a description will be given of the configuration of the document management apparatus where the document management apparatus is realized as an image forming apparatus. FIG. 3 illustrates a configuration where the document management apparatus is realized as an image forming apparatus 10.

The image forming apparatus 10 includes a control unit 11. The control unit 11 is constituted with a Central Processing Unit (CPU), a Random Access Memory (RAM), a Read Only Memory (ROM), an exclusive hardware circuit and similar components and manages the whole operation control of the image forming apparatus 10.

The control unit 11 is connected with an image reading unit 12, an image processor 13, an image memory 14, an image forming unit 15, a dictionary portion 16, an operation unit 18, a facsimile communication unit 19, a network interface unit 20, a storage unit 21 and similar unit. The control unit 11 performs the operation control of the above-described respective units (blocks) that are connected to the control unit 11, and transmits and receives signal or data between the respective blocks and the control unit 11.

The control unit 11 controls the driving and the process of the mechanism that is necessary to perform the operation control of respective functions such as scanner function, printing function, copy function, and facsimile transmitting/receiving function based on the job execution instruction, which is input by the user via the operation unit 18, a network-connected PC, or a similar device.

The control unit 11 includes an OCR processor 11a, an input control unit 11b, a reading control unit 11c, a detecting unit 11d, a searching unit 11e, a storage control unit 11f, a sentence accepting unit 11g, an attribution acquiring unit 11h, an attribution collation unit 11i, a character string selector 11j, and an output control unit 11k. The OCR processor 11a, the input control unit 11b, the reading control unit 11c, the detecting unit 11d, the searching unit 11e, the storage control unit 11f, the sentence accepting unit 11g, the attribution acquiring unit 11h, the attribution collation unit 11i, the character string selector 11j, and the output control unit 11k are function blocks that are realized by the CPU executing the program loaded from the ROM as a non-transitory recording medium or similar medium to the RAM.

The OCR processor 11a, the input control unit 11b, the reading control unit 11c, the detecting unit 11d, the searching unit 11e, the storage control unit 11f, the sentence accepting unit 11g, the attribution acquiring unit 11h, the attribution collation unit 11i, the character string selector 11j, and the output control unit 11k respectively correspond to the OCR processor 7a, the input control unit 7b, the reading control unit 7c, the detecting unit 7d, the searching unit 7e, the storage control unit 7f, the sentence accepting unit 7g, the attribution acquiring unit 7h, the attribution collation unit 7i, the character string selector 7j, and the output control unit 7k in FIG. 2.

The image reading unit 12 is a circuit that reads image from the document and corresponds to the scanner 2 in FIG. 2.

The image processor 13 is a circuit that performs image processing of image data of the image that is read by the image reading unit 12 as necessary. For example, the image processor 13 performs image processing such as shading correction to improve the quality of the image read by the image reading unit 12 after the performed image formation.

The image memory 14 is a circuit that has a region that temporarily stores document image data obtained by reading by the image reading unit 12 and temporarily stores data that is a print target in the image forming unit 15.

The image forming unit 15 is a circuit that performs image formation of image data read by the image reading unit 12 or similar data.

The dictionary portion 16 corresponds to the dictionary 8 in FIG. 2.

The operation unit 18 is a circuit that includes a touch panel and an operation key that accept the instruction, which is related to the various performances and processes that are executable by the image forming apparatus 10, from the user. The touch panel includes a display unit 18a such as a Liquid Crystal Display (LCD) where a touch panel is located. The operation unit 18 corresponds to the input unit 6 in FIG. 2.

The facsimile communication unit 19 is a circuit that includes an encoding/decoding unit, a modulation and demodulation unit, and Network Control Unit (NCU) (not illustrated) and performs facsimile transmission with use of a dial-up line network.

The network interface unit 20 is a circuit that is constituted with communication module such as LAN board. The network interface unit 20 performs transmission and reception of various data with a device inside a local area (external equipment such as a server and a PC) via LAN or similar network connected to the network interface unit 20.

The storage unit 21 stores document image read by the image reading unit 12 or similar data and stores the character string and its note or similar data that are registered in the character string registration mode. The storage unit 21 is a circuit such as a large capacity storage device of Hard Disk Drive (HDD) or similar device.

A configuration where the document management apparatus is realized as an image forming apparatus is described above.

### Configuration Where Document Management Apparatus is Realized as Client/Server Type

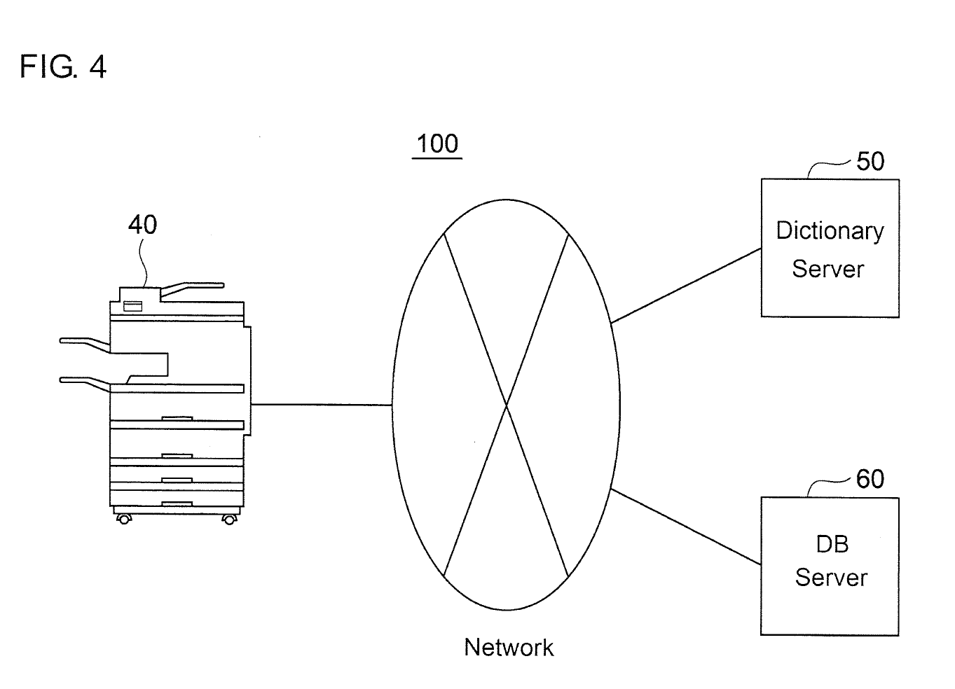

Next, a description will be given of a configuration where the document management apparatus is realized as a client/server type document management system mainly an image forming apparatus. FIG. 4 illustrates the configuration where the document management apparatus is realized as a client/server type document management system 100 mainly an image forming apparatus.

An image forming apparatus 40, a dictionary server 50, and a database (DB) server 60 communicate one another via the network, so as to realize the document management system 100.

The dictionary server 50 corresponds to the dictionary 8 in FIG. 2 or the dictionary portion 16 in FIG. 3. The dictionary server 50 can be realized with use of any count of common dictionary servers provided on Internet.

The DB server 60 corresponds to the storage unit 5 in FIG. 2 or the storage unit 21 in FIG. 3. The DB server 60 stores the character string registered by the user, the character string (note) indicating the meaning of the registered character string, the user identifier, and the user attribution.

The image forming apparatus 40 is an apparatus where the functions performed by the dictionary server 50 and the DB server 60 are eliminated from the image forming apparatus 10 illustrated in FIG. 3.

The configuration where the document management apparatus is realized as the client/server type document management system mainly an image forming apparatus is described above.

### Flow of Process in Character String Registration Mode

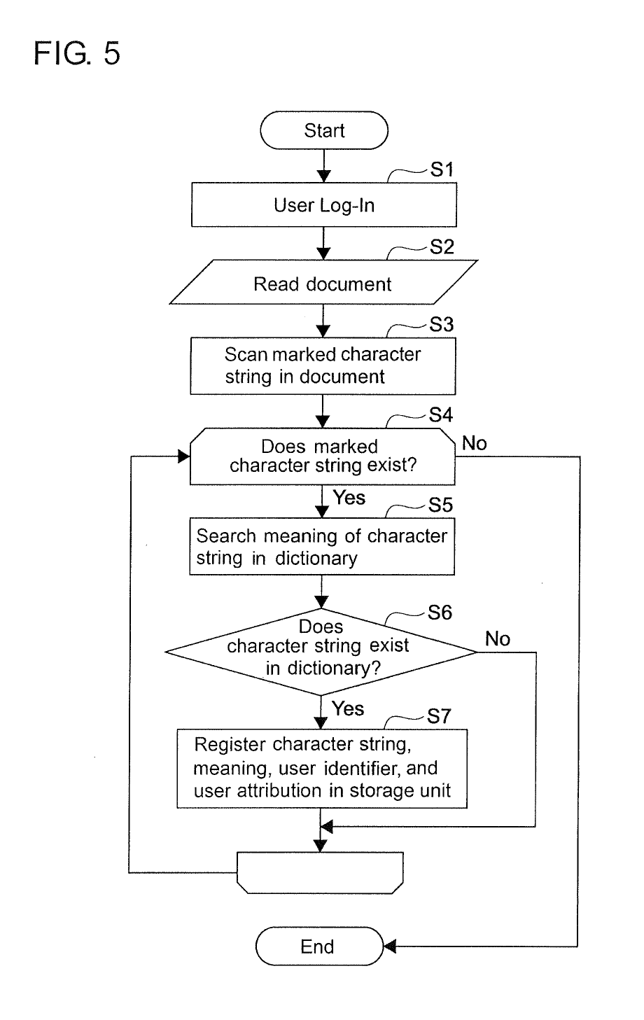

Next, a description will be given of a flow of a process in the character string registration mode. FIG. 5 is a flowchart illustrating the flow of the process in the character string registration mode. The following description will refer to an example where the document management apparatus is realized as an image forming apparatus 10 illustrated in FIG. 3.

First, the input control unit 11b in the control unit 11 performs log-in processing of the user (registrant) via the operation unit 18 (Step S1). This process ensures the user who causes the document management apparatus to read the document with the marked character string to be associated with the preliminarily registered user identifier (user ID) and user attribution.

Here, the user identifier is user information by which the image forming apparatus 10 can identify the user, for example, a name of the user, a login ID, an employee number or similar information.

The user attribution is information that the user can set freely, for example, vocabulary level of the user, specialty, affiliation or similar information.

Next, the reading control unit 11c causes the image reading unit 12 to read the document in which the character string is marked (Step S2).

Next, the OCR processor 11a scans the character string that the user registers based on the position of the mark entered in the read document (Step S3).

Next, the detecting unit 11d of the control unit 11 determines whether or not the marked character string exists (Step S4).

When the marked character string exists (Yes in Step S4), the searching unit 11e in the control unit 11 first searches the character string (note) indicating a meaning of the marked character string with use of the dictionary portion 16 (Step S5).

Next, the searching unit 11e in the control unit 11 determines whether or not the marked character string exists in the dictionary portion 16 (Step S6).

When the marked character string exists in the dictionary portion 16 (Yes in Step S6), the storage control unit 11f in the control unit 11 causes the storage unit 21 to store four pieces of information of the marked character string, the meaning of the character string, the corresponding user identifier, and the corresponding user attribution (Step S7).

The process from Step S5 to Step S7 is performed repeatedly for each of the marked character strings.

The flow of the process in the character string registration mode is described above.

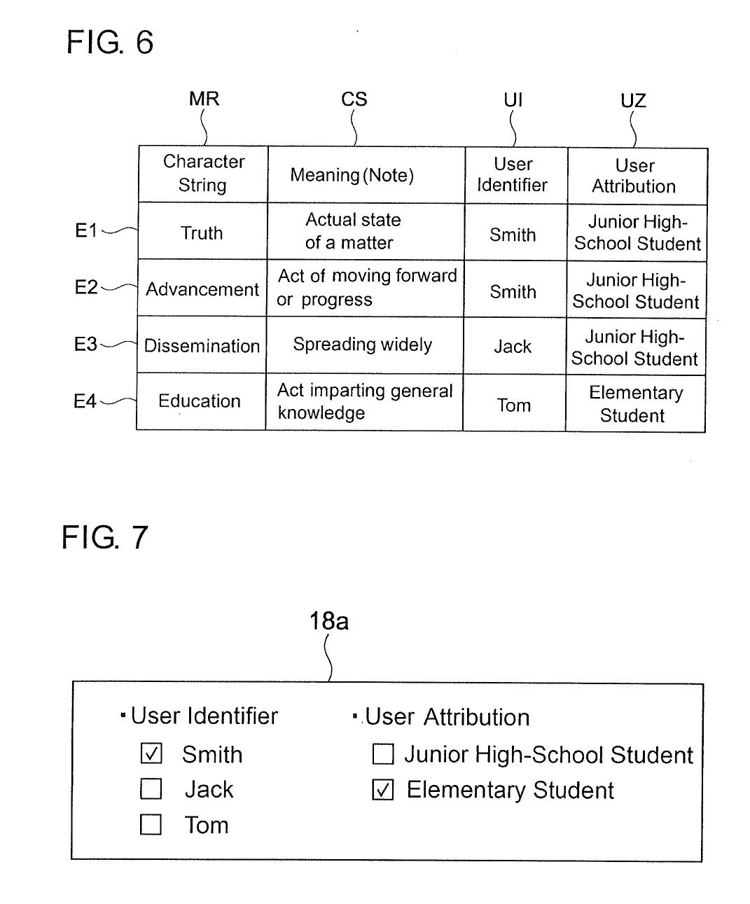

Next, a description will be given of an example of the information registered in the storage unit 21. FIG. 6 illustrates the example of the information registered in the storage unit 21.

One entry is constituted of a character string MR, a character string CS (note), a user identifier UI and a user attribution UZ. The character string CS (note) is a character string that indicates the meaning of the character string MR. The user identifier UI is a user identifier of the user who has registered the character string MR. A user attribution UZ is a user attribution of the user who registered the character string MR.

For example, in a first entry E1, “truth” is registered as the character string MR, “actual state of things” is registered as the character string CS (note), “Smith” is registered as the user identifier UI, “junior high-school student” is registered as the user attribution UZ. Thus, the character string MR is stored in the storage unit 21 associated with the user identifier UI and the user attribution UZ.

The example of the information registered in the storage unit 21 is described above.

### Example of Method to Specify User Identifier and User Attribution

Next, a description will be given of an example of the method for the user to specify the user identifier UI and the user attribution UZ, which are the criteria to select the character string to insert the note, in the sentence output mode. FIG. 7 illustrates a screen example of the display unit 18a as an example of the method for the user to specify the user identifier UI and the user attribution UZ that are the criteria to select the character string to insert the note in the sentence output mode.

In the screen example of the display unit 18a illustrated in FIG. 7, the list of the user identifier UI stored in the storage unit 21 is indicated in the left side, and the list of the user attribution UZ stored in the storage unit 21 is indicated in the right side.

FIG. 7 indicates the state where the user selects “Smith” as the user identifier UI, and selects “elementary student” as the user attribution UZ. Here, although Smith is a junior high-school student, “elementary student” is selected meaningly. This ensures to indicate also comparatively simple terms at the level of the elementary student.

Assume that the storage unit 21 stores information indicated in FIG. 6. When “Smith” is selected as the user identifier UI and “elementary student” is selected as the user attribution UZ, the control unit 11 extracts the entries E1 and E2 that correspond to “Smith” and further extracts an entry E4 that corresponds to “elementary student.”

Consequently, when the sentence to output includes the character strings of “truth,” “advancement,” and “education,” the notes corresponding to these character strings are output with the sentence.

The example of the method for the user to specify the user identifier UI and the user attribution UZ that are the criteria to select the character string to insert the note in the sentence output mode is described above.

### Flow of Process in Sentence Output Mode

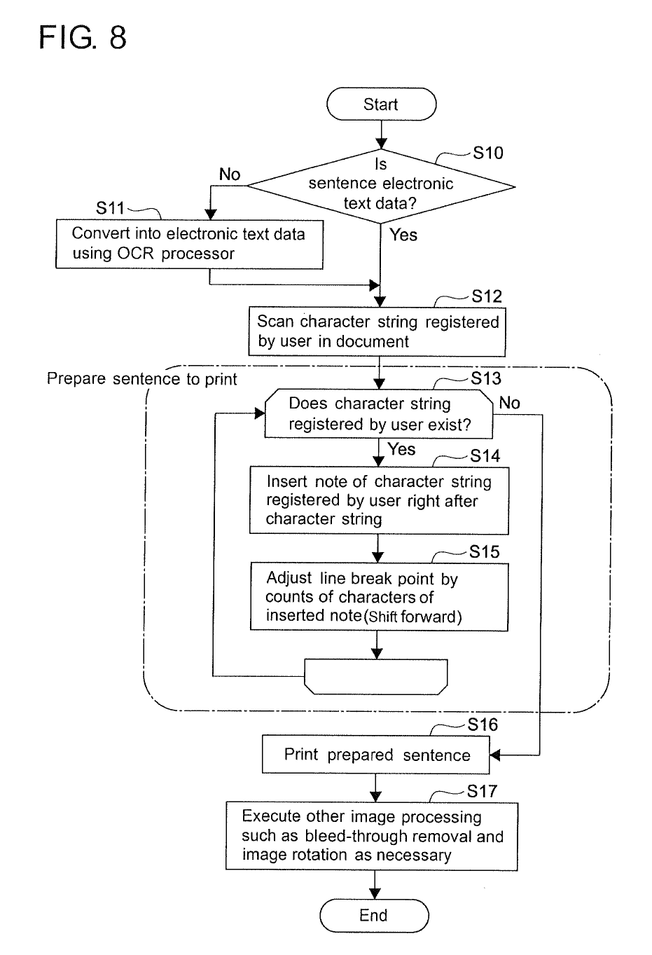

Next, a description will be given of the flow of the process in the sentence output mode. FIG. 8 is a flowchart illustrating the flow of the process in the sentence output mode. The following description will refer to an example where the document management apparatus is realized as the image forming apparatus 10 illustrated in FIG. 3.

First, the sentence accepting unit 11g of the control unit 11 obtains the sentence, which becomes the original of the sentence to output from the user, and determines whether or not the obtained sentence is electronic text data (Step S10). As the method to obtain the sentence, for example, the image reading unit 12 can be used to obtain the sentence as image data, or the external equipment such as Personal Computer (PC) can receive the sentence via the network.

When the obtained sentence is not the electronic text data (No in Step S10), the subsequent process cannot be performed as it is. In view of this, the control unit 11 uses the OCR processor 11a to convert the read image data into the electronic text data (Step S11).

Next, the control unit 11 collates the obtained sentence with the character string corresponding to the user identifier and the user attribution (Step S12). The user identifier and the user attribution are specified by the user with the above-described specifying method or similar way and stored in the storage unit 21. That is, the control unit 11 collates the obtained sentence with the character string MR that is associated with the user identifier UI and the user attribution UZ and stored in the storage unit 21.

Next, the control unit 11 determines whether or not the obtained sentence includes the character string corresponding to the user identifier and the user attribution specified by the user (Step S13).

When the character string corresponding to the user identifier and the user attribution specified by the user is included (Yes in Step S13), the control unit 11 inserts the character string (note) that indicates the meaning of the character string corresponding to the user identifier and the user attribution specified by the user, immediately after the corresponding character string in the obtained sentence (Step S14).

Here, the character string (note) that indicates the meaning of the character string corresponding to the user identifier and the user attribution specified by the user is inserted immediately after the character string corresponding to the user identifier and the user attribution specified by the user in the obtained sentence. However, the disclosure is not limited to this configuration, for example, the character string (note) that indicates the meaning of the character string corresponding to the user identifier and the user attribution specified by the user may be added as a footnote.

The configuration where the character string (note) that indicates the corresponding meaning is entered in a balloon may be applicable. The balloon is pulled out from the character string corresponding to the user identifier and the user attribution specified by the user in the obtained sentence.

Next, the control unit 11 adjusts the position of the line break of the sentence by the counts of characters of the inserted note in order to form the sentence to output corresponding to the insertion (Step S15). The adjustment can be performed by shifting the line break position forward or similar way.

The processes of Step S14 and S15 are performed repeatedly for each of the character strings to insert the note.

When the character string corresponding to the user identifier and the user attribution specified by the user does not exist (No in Step S13), the control unit 11 executes the printing process of the prepared sentence (Step S16).

Next, the control unit 11 executes the other image processing such as bleed-through removal and image rotation as necessary (Step S17).

The flow of the process in the sentence output mode is described above.

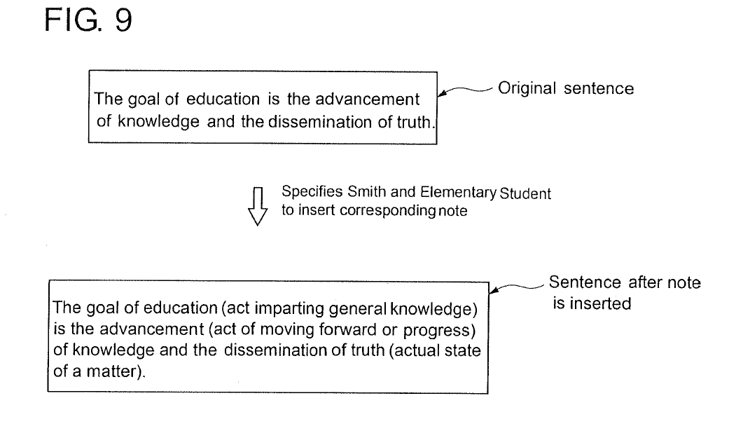

Finally, a description will be given of an example where the character string (note) indicating the meaning of the character string corresponding to the user identifier and the user attribution specified by the user is inserted to the obtained sentence. FIG. 9 illustrates an example where the character string (note) indicating the meaning of the character string corresponding to the user identifier and the user attribution specified by the user is inserted to the obtained sentence.

This example assumes that the information illustrated in FIG. 6 is stored in the storage unit 21, and the user identifier and the user attribution illustrated in FIG. 7 are specified.

Then, immediately after the character strings of “truth,” “education,” and “advancement,” the character strings (note) indicating the meaning of these character strings are inserted and the position of the line break is adjusted.

The example where the character string (note) indicating the meaning of the character string corresponding to the user identifier and the user attribution specified by the user is inserted to the obtained sentence is described above.

The first embodiment is described above.

### Second Embodiment

Next, a description will be given of the second the embodiment.

First, as the outline of the second the embodiment, a description will be given of the difference from the first embodiment.

In the first embodiment, in the sentence output mode, the user explicitly specifies the user identifier UI and the user attribution UZ. In contrast to this, in the second the embodiment, in the sentence output mode, the user identifier UI and the user attribution UZ are determined and input automatically.

This configuration ensures eliminating the labor of the user to specify the user identifier UI and the user attribution UZ.

In the configuration of the first embodiment, there may be cases where, with specified an inappropriate user attribution UZ by the user, the note is inserted to the character string where the note is unnecessary for the user, or the note is not inserted to the character string where the note is necessary for the user.

However, the configuration of the second embodiment specifies the user attribution UZ automatically. Accordingly, the configuration of the second embodiment ensures eliminating the excess and deficiency of inserting the note caused by the specification of the inappropriate user attribution UZ.

Note that the document management apparatus according to the embodiment determines, in the sentence output mode, a pertaining attribution between the attribution of the writer who composed the sentence to output and the attribution of the user who outputs the sentence where the note is inserted. Then, among the character strings registered in the dictionary, the document management apparatus according to the embodiment does not inserts the note to the character string with the attribution according to the determined pertaining attribution.

For example, assuming that a user A outputting a sentence has “science” as the attribution of specialty, and a writer B who composed the sentence to output has “science” as the attribution of specialty. In this case, the document management apparatus extracts “science” as the pertaining attribution between the user A and the writer B.

Then, when searching the character string with “science” as the extracted pertaining attribution in the dictionary to hit the character string C, the document management apparatus does not insert the character string indicating the meaning of a character string C after the character string C even when the sentence to output includes the character string C.

In this type of the process, for example, when a user D who has registered a character string C has “science” as the attribution of specialty, the user A who outputs the sentence where the note is inserted, and the writer B who has composed the sentence where the note is inserted also have “science” as the attribution of specialty, the user A is assumed to have a lot of knowledge with respect to the character string (term) relating to science. In view of this, it is assumed that the note has not been inserted to the character string C registered by the user D.

As the outline of the second embodiment, the difference from the first embodiment is described above.

Next, a description will be given of the configuration of the document management apparatus according to the second embodiment of the disclosure. The document management apparatus according to the second embodiment, as well as the first embodiment, can be realized as the document management apparatus 1, the image forming apparatus 10, and the document management system 100.

Accordingly, the configuration is identical except a part of the flow of the process in the control unit 7 or the control unit 11. Therefore, the detailed description is omitted.

The configuration of the document management apparatus according to the second embodiment of the disclosure is described above.

The flow of the process in the character string registration mode is identical with the flow of the process in the first embodiment. Therefore, the description is omitted.

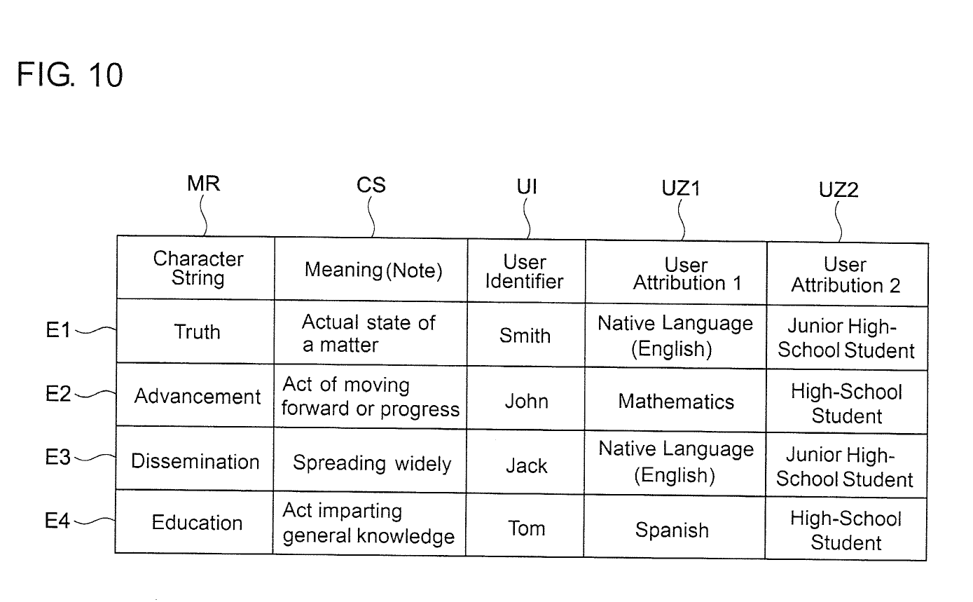

Next, a description will be given of an example of the information stored in the storage unit 21. FIG. 10 illustrates an example of the information stored in the storage unit 21.

One entry includes the character string MR, the character string (note) CS indicating the meaning of the character string MR, the user identifier UI of the user who has registered the character string MR, user attributions UZ1 and UZ2 of the user who has registered the character string MR.

For example, in the first entry E1, “truth” is registered as the character string MR, “actual state of a matter” is registered as the meaning CS, “Smith” is registered as the user identifier UI, “native language (English)” is registered as the user attribution UZ1 indicating the specialty of the user, and “junior high-school student” is registered as the user attribution UZ2 indicating the level of the user (high or low degree of the specialization).

While in this example used two user attributions UZ1 and UZ2, the count of the user attribution stored in the storage unit 21 may be any count insofar as the user attribution can be set appropriately.

In the process of determining the character string to use for inserting the meaning (described below), the user attributions include an user attribution to determine identical or different (such as “native language (English)” and “science”), and an user attribution to determine the relationship of the age (older or younger) or the relationship of the degree (such as “elementary student”<“junior high-school student”<“high-school student”).

Using these user attributions appropriately ensures the character string used for inserting the meaning to be selected appropriately.

The example of the information registered in the storage unit 21 is described above.

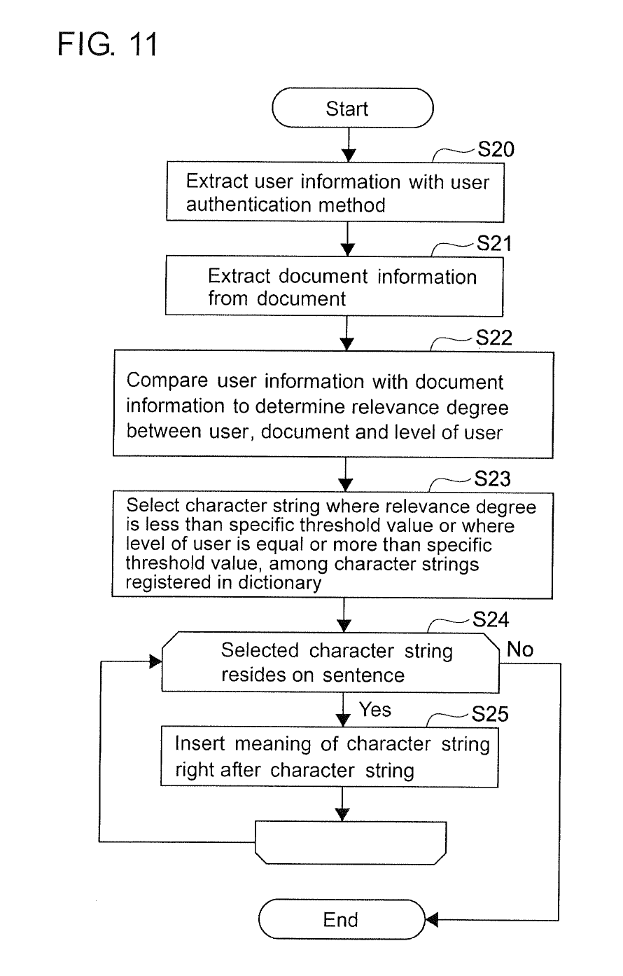

Next, a description will be given of the flow of the process in the sentence output mode. FIG. 11 is a flowchart illustrating the flow of the process in the sentence output mode. The following description will refer to an example where the document management apparatus is realized as one image forming apparatus 10 illustrated in FIG. 3.

First, the input control unit 11b authenticates the user as the output person outputting the sentence by reading one's ID card, inputting one's ID number, or similar way. The input control unit 11b obtains the user information based on the authentication information used for the authentication (Step S20). The obtained user information includes the user identifier UI and the user attributions UZ1 and UZ2 as described above.

Next, the attribution acquiring unit 11h extracts the document information from the document that the user attempts to output (Step S21). The extracted document information includes the user identifier UI to identify the user as the writer who has created (or revised) the document and the user attributions UZ1 and UZ2 indicating the attribution of the user as the writer.

Next, the attribution collation unit 11i compares the user information with the document information to determine the relevance degree between the user and the document and the level of the user (Step S22).

Next, the character string selector 11j selects: the character string where the relevance degree is less than specific threshold value, or the character string where the level of the user is equal to or more than specific threshold value, among the character strings registered in the dictionary portion 16 (Step S23).

Next, the control unit 11 executes the following process for each of the selected character strings (Step S24). After the process for each of the selected character strings completes, the sentence with the inserted note is output via the output control unit 11k.

When the selected character string resides on the document, the control unit 11 inserts the character string (note) indicating the meaning of the character string immediately after the character string in the document (Step S25).

The flow of the process in the sentence output mode is described above.

Next, a description will be given of an example of the method where, in the sentence output mode, the control unit 11 automatically selects the user identifier UI and the user attribution UZ1 and UZ2 that are the criteria to choose the character string to which the note is inserted.

In the following description, the information is stored in the storage unit 21 as the example of the information illustrated in FIG. 10.

### EXAMPLE 1

Assume that the user who outputs the document into which the note is inserted has the following attributions.
User Identifier UI: Ted
User Attribution UZ1: native language (English)
User Attribution UZ2: junior high-school student

Assume that the user as the writer who has created the document into which the note is inserted has the following attributions.
User Identifier UI: Smith
User Attribution UZI: native language (English)
User Attribution UZ2: junior high-school teacher

Assume that the specific threshold value used for the process is two. The threshold value may be set at a specific value when the document management apparatus is shipped from the plant, or may be changed accordingly by an administrator in operating the document management apparatus with determining the amount of the notes to be inserted.

In this case, since the attribution “native language (English)” is identical, and the attribution “junior high-school” is pertaining between the user and the writer, the relevance degree is determined as two.

Then, with the specific threshold value as two, the note is inserted to the character string except the character strings where the two attributions of “native language (English)” and “junior high-school” are identical or pertaining, among the character string registered in the dictionary portion 16.

Namely, except the entries E1 and E3 where “native language (English)” and “junior high-school” are identical or pertaining, the notes of an entry E2 (advancement) and the entry E4 (education) are inserted after the character strings in the document.

### EXAMPLE 2

Assume that the user who outputs the document into which the note is inserted has the following attributions.
User Identifier UI: Hans
User Attribution UZ1: science
User Attribution UZ2: high-school student

Assume that the user as the writer who has created the document into which the note is inserted has the following attributions.
User Identifier UI: Ted
User Attribution UZ1: science
User Attribution UZ2: elementary student

Assume that the specific threshold value used for the process is one.

In this case, between the user and the writer, the one attribution “science” is identical (pertaining). Accordingly, the relevance degree is determined as one.

Then, with the specific threshold value as one, the note is inserted to the character string except the character string where the attribution of “science” is identical among the character strings registered in the dictionary portion 16.

Namely, except the entry E2 where “science” is identical, the notes of the entry E1 (truth), an entry E3 (dissemination), and the entry E4 (education) are inserted after the character strings in the document.

### EXAMPLE 3

Assume that the user who outputs the document into which the note is inserted has the following attribution.
User Identifier UI: Hattori
User Attribution UZ1: science
User Attribution UZ2: junior high-school student

Assume that the user as the writer who created the document into which the note is inserted has the following attribution.
User Identifier UI: Kevin
User Attribution UZ1: science
User Attribution UZ2: high-school student

Assume that the specific threshold value used for the process is one.

In this case, since the one attribution “science” is identical (pertaining) between the user as the output person and the user as the writer, the relevance degree is determined as one.

In this case, the user attribution UZ2 indicating the level of the user is “junior high-school student.” In contrast to this, the user attribution UZ2 indicating the level of the writer of the document is “high-school student.” High-school students are assumed to have more vocabulary where the meaning can be understood than those of junior high-school students. Accordingly, among the character strings registered in the dictionary portion 16, only the character strings where the user attribution UZ2 is equal to or more than “high-school student” are subject to insert the note.

Then, only the notes of the entry E2 (advancement) and the entry E4 (education), which the user attribution UZ2 is “high-school student,” are inserted after the character string in the document.

The example of the method where, in the sentence output mode, the control unit 11 automatically selects the user identifier UI and the user attributions UZ1 and UZ2 that are the criteria to choose the character string to which the note is inserted, is described above.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A document management apparatus comprising:
a reading circuit that reads a character string and a marking from a document where a character string is marked;
a storage circuit; and
a control circuit
wherein the control circuit has:
a character string registration mode that causes the reading circuit to read the document, detects a character string to be annotated based on a position of the read marking, searches the note of the detected character string in a dictionary, and causes the storage circuit to store the detected character string and the searched note to register the character string, and
a sentence output mode that accepts a sentence, collates the accepted sentence with the character string stored in the storage circuit, obtains the note of the character string found to be matched by the collation, and makes the obtained note correspond to the matched character string to output the obtained note together with the sentence, so as to output the sentence.

2. The document management apparatus according to claim 1, further comprising
an input circuit that accepts a user identifier for identifying a user who operates the document management apparatus,
wherein in the character string registration mode, the control circuit associates the detected character string with the user identifier and causes the storage circuit to store the detected character string and the user identifier, and
in the sentence output mode, the control circuit obtains the user identifier from the input circuit and collates the sentence with the character string stored in the storage circuit and associated with the obtained user identifier.

3. The document management apparatus according to claim 1, further comprising
an input circuit that accepts attribution information of a user who operates the document management apparatus,
wherein in the character string registration mode, the control circuit associates the detected character string with the attribution information, and causes the storage circuit to store the detected character string and the attribution information, and
in the sentence output mode, the control circuit obtains the attribution information from the input circuit, and collates the sentence with the character string stored in the storage circuit and associated with the obtained attribution information.

4. The document management apparatus according to claim 1,
wherein when outputting the sentence in the sentence output mode, the control circuit embeds the obtained note into a part near the collated character string in the sentence.

5. The document management apparatus according to claim 1,
wherein when outputting the sentence in the sentence output mode, the control circuit outputs the obtained note as a footnote of the sentence.

6. The document management apparatus according to claim 1, further comprising
an input circuit that accepts the attribution of a user as a registrant who registers a character string and the attribution of a user as an output person who outputs a sentence,
wherein the reading circuit reads the character string and the marking from the document where the character string is marked by the registrant, and
the control circuit includes:
an input control circuit that causes the input circuit to accept the attribution of the registrant in the character string registration mode, and causes the input circuit to accept the attribution of the output person in the sentence output mode for outputting the sentence;
a reading control circuit that causes the reading circuit to read the document in the character string registration mode;
a detecting circuit that detects a character string to be annotated based on a position of the read marking;
a searching circuit that searches the note of the detected character string in the dictionary;
a storage control circuit that makes the detected character string, the searched note, and the accepted attribution of the registrant correspond to one another, and causes the storage circuit to store the detected character string, the searched note, and the accepted attribution;
a sentence accepting circuit that accepts the sentence to be output from the output person;
an attribution obtaining circuit that obtains the attribution of a writer of the accepted sentence based on document information of the accepted sentence;
an attribution collating circuit that collates the accepted attribution of the output person, the obtained attribution of the writer, and the stored attribution of the registrant;
a character string selecting circuit that selects the character string stored in the storage circuit based on a result of the collation; and
an output control circuit that makes a note of the selected character string correspond to the character string in the sentence to output the note with the sentence.

7. The document management apparatus according to claim 6,
wherein in the sentence output mode, the attribution collating circuit collates the accepted attribution of the output person with the obtained attribution of the writer to select a matched attribute value, and
in the sentence output mode, the character string selecting circuit selects the character string that does not have the selected attribute value.

8. The document management apparatus according to claim 1,
wherein if the attribution is an attribution indicative of a level of a specialization, in the sentence output mode, the attribution collating circuit collates the accepted attribution of the output person with the obtained attribution of the writer to select a matched attribute value, and
in the sentence output mode, the character string selecting circuit selects the character string having a higher attribute value than the selected attribute value.

9. A non-transitory computer-readable recording medium storing a document management program,
the document management program causing a computer to function as:
a reading circuit that reads a character string and a marking from a document where a character string is marked;
a storage circuit; and
a control circuit
wherein the control circuit has:
a character string registration mode that causes the reading circuit to read the document, detects a character string to be annotated based on a position of the read marking, searches the note of the detected character string in a dictionary, and causes the storage circuit to store the detected character string and the searched note to register the character string, and
a sentence output mode that accepts a sentence, collates the accepted sentence with the character string stored in the storage circuit, obtains the note of the character string found to be matched by the collation, and makes the obtained note correspond to the matched character string to output the obtained note together with the sentence, so as to output the sentence.

10. The recording medium according to claim 9,
the document management program further causes the computer to function as an input circuit that accepts an attribution of a registrant who registers a character string and the attribution of an output person who outputs a sentence,
wherein the reading circuit reads the character string and the marking from the document where the character string is marked by the registrant, and
the control circuit includes:
an input control circuit that causes the input circuit to accept the attribution of the registrant in the character string registration mode, and causes the input circuit to accept the attribution of the output person in the sentence output mode for outputting the sentence;
a reading control circuit that causes the reading circuit to read the document in the character string registration mode;
a detecting circuit that detects a character string to be annotated based on a position of the read marking;
a searching circuit that searches the note of the detected character string in the dictionary;
a storage control circuit that makes the detected character string, the searched note, and the accepted attribution of the registrant correspond to one another, and causes the storage circuit to store the detected character string, the searched note, and the accepted attribution;
a sentence accepting circuit that accepts the sentence to be output from the output person;
an attribution obtaining circuit that obtains the attribution of a writer of the accepted sentence based on document information of the accepted sentence;
an attribution collating circuit that collates the accepted attribution of the output person, the obtained attribution of the writer, and the stored attribution of the registrant;
a character string selecting circuit that selects the character string stored in the storage circuit based on a result of the collation; and
an output control circuit that makes a note of the selected character string correspond to the character string in the sentence to output the note with the sentence.
